(19) United States
(12) Patent Application Publication
(10) Pub. No.: US 2011/0065023 A1
(43) Pub. Date: Mar. 17, 2011

(54) SEALING STRUCTURE AND ELECTRICITY SUPPLY DEVICE

(76) Inventors: Yi-Yie Yan, Hsinchu (TW); Hsu-Lin Chang, Hsinchu (TW)

(21) Appl. No.: 12/880,756

(22) Filed: Sep. 13, 2010

(30) Foreign Application Priority Data
Sep. 15, 2009 (TW) 098131133

(51) Int. Cl. H01M 2/18

(52) U.S. Cl. 429/508

(57) ABSTRACT

An electricity supply device includes two conductive substrates, a chemical-electrical conversion module and a sealing structure. The chemical-electrical conversion module is disposed between the conductive substrates, and includes two diffusion units and a membrane electrode unit. One diffusion unit is disposed adjacent to one conductive substrate while the other diffusion unit is disposed adjacent to the other conductive substrate. The membrane electrode unit is disposed between the two diffusion units. The sealing structure includes a first protruding structure and a second protruding structure. One end of the first protruding structure is against to one conductive substrate. One end of the diffusion unit and one end of the membrane electrode unit are against to the inner side of one end of the first protruding structure. The second protruding structure is disposed next to the first protruding structure. At least one end of the second protruding structure is against to one end of the other diffusion unit and one end of the membrane electrode unit. Meanwhile, a sealing structure used in the electricity supply device is also disclosed.

### CROSS REFERENCE TO RELATED APPLICATIONS

This Non-provisional application claims priority under 35 U.S.C. §119(a) on Patent Application No(s). 098131133 filed in Taiwan, Republic of China on Sep. 15, 2009, the entire contents of which are hereby incorporated by reference.

### BACKGROUND OF THE INVENTION

1. Field of Invention

The invention relates to an electricity supply device and a sealing structure thereof, and in particular, to an electricity supply device and a sealing structure thereof that can enhance the sealing effect and reduce the manufacturing cost.

2. Related Art

For the sake of our environment and planet, it is desired to develop green energy technologies such as the fuel cell technology. The fuel cell can convert the chemical energy of the fuel by the electrochemical reaction to generate electricity.

FIG. 1 is an exploded diagram showing a conventional fuel cell device 1. As shown in FIG. 1, the conventional fuel cell device 1 includes a conductive substrate 12a, a diffusion layer 14a, a membrane electrode 16, a diffusion layer 14b, and a conductive substrate 12b.

The conductive substrates 12a and 12b include reaction areas Ra and Rb and transmission areas Ta and Tb, respectively. When the conductive substrate 12a is a cathode, the conductive substrate 12b is an anode. The transmission areas Ta and Tb allow the fluids to flow around the conductive substrates 12a and 12b, respectively. In this case, the fluid flows around the conductive substrate 12a is a cathode fluid (not shown), and the fluid flows around the conductive substrate 12b is an anode fluid (not shown). In order to form the circuit loop, the diffusion layer 14a disposed adjacent to the conductive substrate 12a and the diffusion layer 14b disposed adjacent to the conductive substrate 12b both have electronic conductivity. The membrane electrode 16 disposed between the diffusion layers 14a and 14b is disposed corresponding to the reaction areas Ra and Rb. In addition, the membrane electrode 16 includes a catalyze layer 161, a catalyze layer 162, and a proton exchange layer 163 disposed between the catalyze layers 161 and 162. The proton exchange layer 163 is solid electrolyte, so that it can separate the catalyze layers 161 and 162, and prevent the fluids flowing around the conductive substrates 12a and 12b from contacting with each other.

In addition, the membrane electrode 16 can separate the cathode and the anode, and the fluids flowing around the cathode and the anode are separated as well. In order to prevent the leakage or mixing of the fluids flowing around the cathode and the anode, it is necessary to configure a sealing body 18a between the membrane electrode 16 and the conductive substrate 12a and a sealing body 18b between the membrane electrode 16 and the conductive substrate 12b. Because the fluid is usually gas, the sealing bodies 18a and 18b are also called a gasket.

As mentioned above, the sealing bodies 18a and 18b are disposed at two opposite sides of the membrane electrode 16. Thus, when assembling the fuel cell device 1, the sealing bodies 18a and 18b must be disposed on the conductive substrate 12a or 12b. For example, if the sealing body 18b is disposed on the conductive substrate 12b in advance, the sealing body 18b can be used as a position reference for disposing the diffusion layer 14b, the membrane electrode 16, the diffusion layer 14a, the sealing body 18a and the conductive substrate 12a in sequence. However, since the sealing body 18a or 18b is not firmly fixed on the conductive substrate 12a or 12b, it may slide that will cause the problems of the positioning of the later components. Moreover, the sealing effect may be very bad. In addition, if the relative positions between the membrane electrode 16 and the sealing bodies 18a and 18b are not accurate, they may have relatively shifting due to the vibration or thermal expansion contraction later. This will affect the usable lifetime of the fuel cell device 1. Besides, two sealing bodies 18a and 18b are needed in the fuel cell device 1, so that the manufacturing cost of the fuel cell device 1 can not be sufficiently reduced. Furthermore, there are too many factors influencing the assembling of the fuel cell device 1, so that the manufacturing yield thereof can be efficiently increased.

In order to solve the above-mentioned bottlenecks of the prior art, the invention is to provide an electricity supply device and a sealing structure thereof that utilize a novel sealing structure design, which can keep the sealing effect and can simplify the assembling of the fuel cell device to reduce the manufacturing cost.

### SUMMARY OF THE INVENTION

An objective of the invention is to provide an electricity supply device and a sealing structure thereof that can use the sealing structure to achieve the purposes of positioning and sealing, thereby simplifying the assembling procedure, increasing the manufacturing yield, and decreasing the manufacturing cost.

Another objective of the invention is to provide an electricity supply device and a sealing structure thereof that can use a single structure to separate the cathode fluid and the anode fluid.

To achieve the above-mentioned objectives, the invention discloses a sealing structure applied in an electricity supply device, which further includes two conductive substrates and a chemical-electrical conversion module disposed between the conductive substrates. The chemical-electrical conversion module includes two diffusion units and a membrane electrode unit disposed between the diffusion units. The sealing structure includes a first protruding structure and a second protruding structure. The first protruding structure is against to two conductive substrates. At least one end of one diffusion unit and at least one end of the membrane electrode unit are against to the inner side of one end of the first protruding structure. The second protruding structure is disposed adjacent to the first protruding structure and is disposed against the other conductive substrate and the membrane electrode unit. At least one end of the other diffusion unit is disposed against the inner side of at least one end of the second protruding structure.

In the invention, the first protruding structure and the second protruding structure are separated components; otherwise, the first protruding structure and the second protruding structure are integrally formed as one piece. At lest one of the first and second protruding structures is flexible. At least one of the first and second protruding structures is made of silica gel, polyvinyl chloride (PVC), Polyethylene (PE), Polypropylene (PP), Polystyrene (PS), or their combinations. The first protruding structure and the second protruding structure may have the same dimension or different dimensions. At least one of the first and second protruding structures is continuously or discontinuously disposed around the edge of the conductive substrate. Each of the conductive substrates has at least one reaction area and at least two fluid transmission areas. Herein, the sealing structure may be continuously or discontinuously disposed around the edge of the reaction area, and/or the sealing structure may be continuously or discontinuously disposed around the edges of fluid transmission areas.

In addition, the invention also discloses an electricity supply device including two conductive substrates, a chemical-electrical conversion module, and a sealing structure. The chemical-electrical conversion module is disposed between the conductive substrates, and includes two diffusion units and a membrane electrode unit, which is disposed between the diffusion units. One of the diffusion units is disposed adjacent to one of the conductive substrates, and the other one of the diffusion units is disposed adjacent to the other one of the conductive substrates. The sealing structure includes a first protruding structure and a second protruding structure. The first protruding structure is disposed against the conductive substrates, and at least one end of one of the diffusion units and at least one end of the membrane electrode unit are disposed against the inner side of at least one end of the first protruding structure. The second protruding structure is disposed adjacent to the first protruding structure, and at least one end of the second protruding structure is disposed against at least one end of the membrane electrode unit and at least one end of the other one of the conductive units.

In the invention, each of the conductive substrates has at least one reaction area and at least two fluid transmission areas, and the reaction area is disposed corresponding to the chemical-electrical conversion module. The reaction area includes at least one fluid channel. The sealing structure is continuously or discontinuously disposed around the edge of the reaction area; otherwise, the sealing structure is continuously or discontinuously disposed around the edges of fluid transmission areas. At least one of the conductive substrates has a surface configured with at least one positioning structure, and the positioning structure is disposed corresponding to the sealing structure. Otherwise, at least one of the conductive substrates has a surface configured with at least one fixing structure for fixing the sealing structure. The membrane electrode unit includes two catalyze units and a proton exchanging unit. One of the catalyze units is disposed between one of the conductive substrates and one of the diffusion units, and the other one of the catalyze units is disposed between the other one of the conductive substrates and the other one of the diffusion units. The proton exchanging unit is disposed between the catalyze units. The first protruding structure and the second protruding structure are separated components or integrally formed as one piece. At lest one of the first and second protruding structures is flexible. At least one of the first and second protruding structures is made of silica gel, polyvinyl chloride (PVC), Polyethylene (PE), Polypropylene (PP), Polystyrene (PS), or their combinations. The first protruding structure and the second protruding structure have the same dimension or different dimensions. The electricity supply device is a fuel cell device.

As mentioned above, the electricity supply device of the invention has a sealing structure configured between two conductive substrates directly. This configuration can simplify the assembling procedure of the electricity supply device, and thus make the positioning of the membrane electrode module more accurate and easier. Moreover, it is cheaper to use only one sealing structure, which can still achieve good seaming effect for preventing the mixing and leakage of the cathode and anode fluids.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is an exploded diagram showing the conventional fuel cell device;

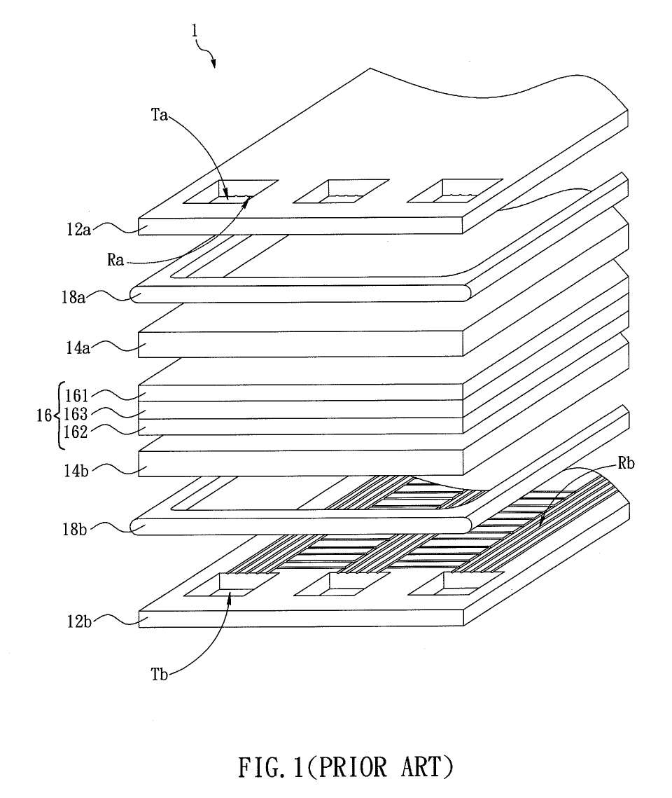

FIG. 2 is a schematic diagram of an electricity supply device according to an embodiment of the invention;

FIG. 3 is a schematic diagram showing the structure of the conductive substrate; and

FIG. 4 is a cross-sectional diagram of the electricity supply device of FIG. 2.

### DETAILED DESCRIPTION OF THE INVENTION

The present invention will be apparent from the following detailed description, which proceeds with reference to the accompanying drawings, wherein the same references relate to the same elements.

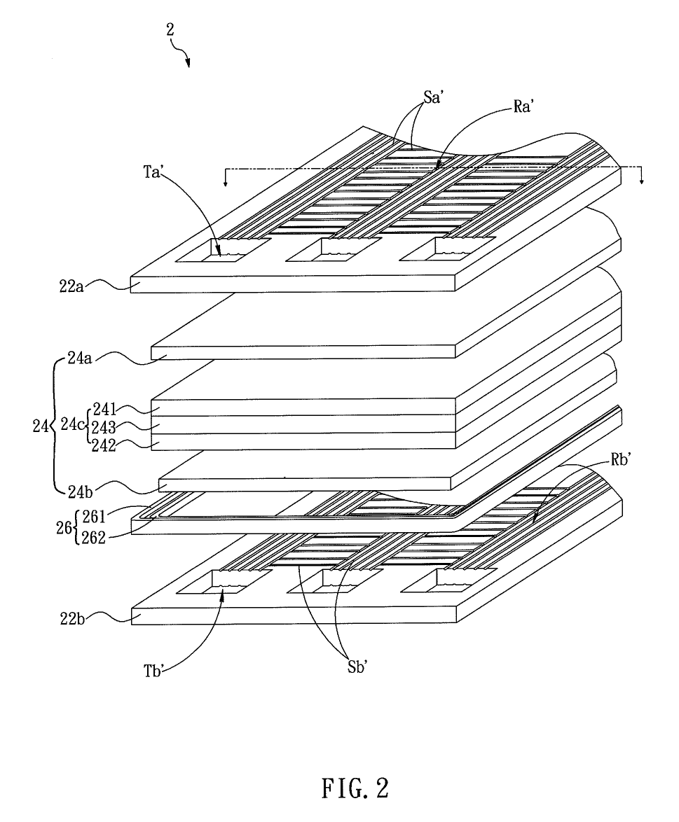

FIG. 2 is a schematic diagram of an electricity supply device according to an embodiment of the invention. As shown in FIG. 2, an electricity supply device 2 includes two conductive substrates 22a and 22b, a chemical-electrical conversion module 24, and a sealing structure 26. The chemical-electrical conversion module 24 is disposed between the conductive substrates 22a and 22b, and includes two diffusion units 24a and 24b and a membrane electrode unit 24c. The diffusion unit 24a is disposed adjacent to the conductive substrate 22a, and the other diffusion unit 24b is disposed adjacent to the other conductive substrate 22b. The membrane electrode unit 24c is disposed between the diffusion units 24a and 24b. The sealing structure 26 includes a first protruding structure 261 and a second protruding structure 262. The first protruding structure 261 is disposed against the conductive substrate 22a, and the diffusion unit 24a and the membrane electrode unit 24c are disposed against the inner side of the first protruding structure 261. The second protruding structure 262 is disposed adjacent to the first protruding structure 261, and is disposed against the other conductive unit 22b and the membrane electrode unit 24c. In this embodiment, only at least one end of the diffusion unit 24a and at least one end of the membrane electrode unit 24c disposed against the inner side can be enough to achieve the fixing purpose, and they do not have to totally against the inner side.

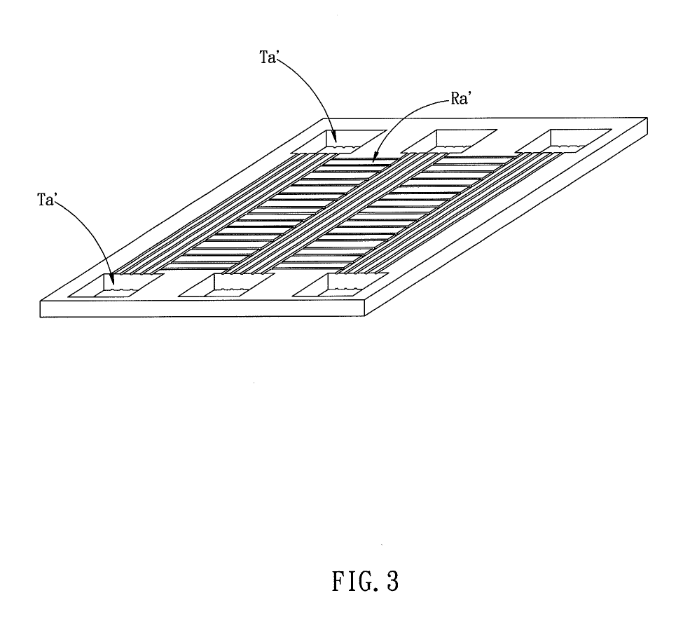

FIG. 3 is a schematic diagram showing the structure of the conductive substrate. Referring to both FIG. 2 and FIG. 3, the conductive substrates 22a and 22b are used as the cathode conductive substrate and the anode conductive substrate, respectively. Regarding to their functions, the conductive substrate 22a has at least one reaction area Ra′ and at least two fluid transmission areas Ta′, and the conductive substrate 22b has at least one reaction area Rb′ and at least two fluid transmission areas Tb′. A part of the fluid transmission areas Ta′ and Tb′ can allow the fluid flowing into the reaction areas Ra′ and Rb′, and the other part of the fluid transmission areas Ta′ and Tb′ can allow the reacted fluid flowing out. Since the reaction areas Ra′ and Rb′ are the major chemical-electrical conversion areas, they are disposed corresponding to the chemical-electrically conversion module 24. In addition, in order to increase the reaction rate of the fluids, the reaction areas Ra′ and Rb′ are further configured with several fluid channels Sa′ and Sb′, and the fluids can flow from the fluid transmission areas Ta′ and Tb′ to the wandered and high-density fluid channels Sa′ and Sb′. Thus, the fluids can homogeneously distributed to the entire reaction areas Ra′ and Rb′. To be noted the design of the fluid channels Sa′ and Sb′ can be various depending on different demands. Of course, the conductive substrates 22a and 22b may have only one surface that is configured with the fluid channels Sa′ and Sb′. In practice, multiple of electricity supply devices may be connected in serial or in parallel to provide the desired voltage or current, so that the major surfaces of the conductive substrate 22a or 22b can all be configured with the fluid channels Sa′ or Sb′. Thus, the conductive substrate 22a or 22b can be independently applied to two electricity supply devices. In this embodiment, the two major surfaces of the conductive substrate 22a (or 22b) are configured with the fluid channels Sa′ (or Sb′).

Since the conductive substrates 22a and 22b must have proper rigidity for supporting and protecting the components configured therein, proper flexibility for absorbing the structural stress during assembling, and good conductivity, they are usually made of the composition containing carbon and polymer. Of course, metal or alloy can also be used as the material of the conductive substrates 22a and 22b.

Referring to FIG. 2, the chemical-electrical conversion module 24 includes two diffusion units 24a and 24b, and a membrane electrode unit 24c. The membrane electrode unit 24c is disposed between the diffusion units 24a and 24b, and is located corresponding to the reaction areas Ra′ and Rb′ of the conductive substrates 22a and 22b. In this embodiment, the membrane electrode unit 24c further includes two catalyze units 241 and 242, and a proton exchanging unit 243, which is disposed between the two catalyze units 241 and 242. In other words, in one direction, the catalyze unit 241 and the diffusion unit 24a are stacked on the proton exchanging unit 243 in sequence, and, in the other direction, the catalyze unit 242 and the diffusion unit 24b are stacked on the proton exchanging unit 243 in sequence.

As mentioned above, when the conductive substrate 22a is used as the cathode substrate of the electricity supply device, the diffusion unit 24a and the catalyze unit 241 disposed between the conductive substrate 22a and the proton exchanging unit 243 are included in the general cathode. On the contrary, when the conductive substrate 22a is used as the anode substrate of the electricity supply device, the diffusion unit 24a and the catalyze unit 241 disposed between the conductive substrate 22a and the proton exchanging unit 243 are included in the general anode.

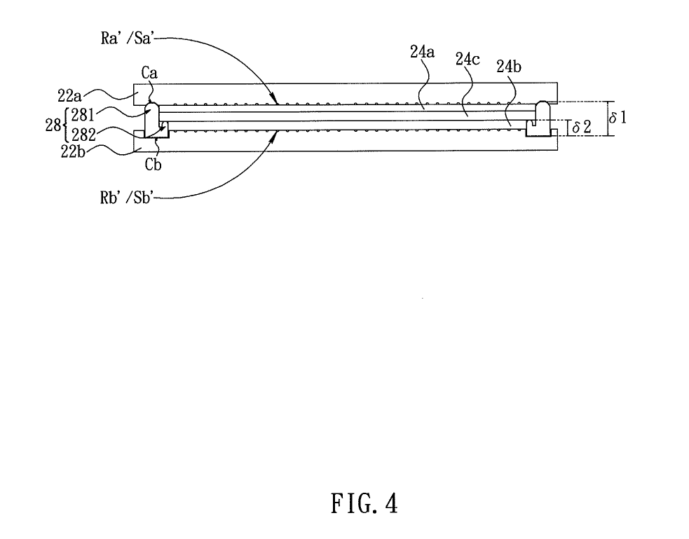

FIG. 4 is a cross-sectional diagram of the electricity supply device of FIG. 2. With reference to FIG. 2 and FIG. 4, the sealing structure 26 includes a first protruding structure 261 and a second protruding structure 262. The dimension of the first protruding structure 261 is larger than that of the second protruding structure 262. In this case, the thickness M of the first protruding structure 261 is larger than the thickness δ2 of the second protruding structure 262.

In more detailed, as shown in FIG. 4, the first protruding structure 261 is disposed against and between the conductive substrates 22a and 22b, and the diffusion unit 24a and the membrane electrode unit 24c are disposed against the inner side of the first protruding structure 261. In other words, the conductive substrate 22a, the membrane electrode unit 24c and the first protruding structure 261 can configure an airtight space, so that the fluid flowing from the fluid transmission area Ta′ of the conductive substrate 22a can be sealed between the conductive substrate 22a and the membrane electrode unit 24c, thereby preventing the fluid leakage and the mixing with outside fluid. Similarly, the second protruding structure 262 is disposed against and between the conductive substrate 22b and the membrane electrode unit 24c, so that the conductive substrate 22b, the membrane electrode unit 24c and the second protruding structure 262 can configure an airtight space. Accordingly, the fluid flowing from the fluid transmission area Tb′ of the conductive substrate 22b can be sealed between the conductive substrate 22b and the membrane electrode unit 24c, thereby preventing the fluid leakage and the mixing with outside fluid or the other fluid.

In this embodiment, the first protruding structure 261 and the second protruding structure 262 are integrally formed as one piece. In other words, the first protruding structure 261 and the second protruding structure 262 are not connected with each other. To be noted, depending on different designs or demands, the first protruding structure 261 and the second protruding structure 262 may be separated components. Besides the above-mentioned configuration of disposing the sealing structure 26 at the edges of the reaction areas Ra′ and Rb′ of the conductive substrates 22a and 22b, the sealing structure 26, which includes the first and second protruding structures 261 and 262, may be further disposed at the edges of the fluid transmission areas Ta′ and Tb′ of the conductive substrates 22a and 22b for preventing leakage when the fluid flows in to or out of the fluid transmission areas Ta′ and Tb′. To be noted, the first and second protruding structures 261 and 262 of the embodiment are both continuous structures, but at least one of them may be changed as a discontinuous structure according to different designs of, for example, the conductive substrates 22a and 22b.

Regarding to the assembling procedure of the electricity supply device 2, the sealing structure 26 is firstly disposed on the conductive substrate 22b, and then the diffusion unit 24b, the catalyze unit 242, the proton exchanging unit 243, the catalyze unit 241, and the diffusion unit 24a are stacked thereon in order. After that, the other conductive substrate 22a is finally disposed thereon so as to finish the assembling of the electricity supply device 2. In more detailed, the dimensions (or areas) of the diffusion unit 24b and catalyze unit 242 are usually similar to or slightly smaller than the enclosed area of the second protruding structure 262. Thus, the diffusion unit 24b and catalyze unit 242 can be easily disposed inside the second protruding structure 262. Besides, the dimension (or area) of the membrane electrode unit 24c is slightly larger than that of the diffusion unit 24b, and the membrane electrode unit 24c is disposed against both of the first and second protruding structures 261 and 262. Similarly, the dimensions of the other catalyze unit 241 and diffusion unit 24a are usually similar to or slightly smaller than the enclosed area of the first protruding structure 261, so that the catalyze unit 241 and diffusion unit 24a can be easily disposed inside the first protruding structure 261. In this case, the diffusion unit 24b and catalyze unit 242 disposed at one side of the membrane electrode unit 24c can be sealed by the second protruding structure 262, so that the fluid located in this area can be prevented from leaking or mixing with other fluid. Similarly, the catalyze unit 241 and diffusion unit 24a disposed at the other side of the membrane electrode unit 24c can be sealed by the first protruding structure 261, so that the fluid located in this area can be prevented from leaking or mixing with other fluid. Of course, the above-mentioned two fluids located in the reaction areas Ra′ and Rb′ can be isolated by the membrane electrode unit 24c.

In order to make the assembling procedure more simple and convenient, the conductive substrates 22a and 22b may further be configured with at least one positioning structure Ca and at least one positioning structure Cb, respective, which are disposed corresponding to the sealing structure 26. Thus, the sealing structure 26 can be easily and accurately positioned on the proper location. For example, the positioning structures Ca and Cb can be recesses, protruding slots, or protrusions. In this embodiment, the positioning structures Ca and Cb are protruding slots, so that the sealing structure 26 can be positioned depending on the positioning structures Ca and Cb formed on the surfaces of the conductive substrates 22a and 22b. Except for the above-mentioned positioning structures Ca and Cb, each of the conductive substrates 22a and 22b may further be configured with at least one fixing structure (not shown), which is disposed corresponding to the sealing structure 26, for fixing the sealing structure 26 on the conductive substrates 22a and 22b. Thus, the sealing structure 26 can be firmly connected with the conductive substrates 22a and 22b for avoiding sliding and shifting, which may influence the sealing effect. In this embodiment, the fixing structure can be a hook, a protruding slot or a protrusion.

To be noted, since the sealing structure 26 can be formed by flexible materials, such as silica gel, polyvinyl chloride (PVC), Polyethylene (PE), Polypropylene (PP), Polystyrene (PS), or their combinations, it can also absorb the assembling stress during the assembling procedure. Thus, the assembling stress can compress the sealing structure 26 to generate a deformation of the sealing structure 26, which can enhance the sealing effect. In addition, since the flexible sealing structure 26 can absorb the extra assembling stress, the electricity supply device 2 can sustain larger external force. This can achieve the purpose of strengthening the structure of the electricity supply device 2.

In summary, the electricity supply device of the invention has a sealing structure configured between two conductive substrates directly. This configuration can simplify the assembling procedure of the electricity supply device, and thus make the positioning of the membrane electrode module more accurate and easier. Moreover, it is cheaper to use only one sealing structure, which can still achieve good seaming effect for preventing the mixing and leakage of the cathode and anode fluids. Compared with the prior art, which uses two sealing bodies to seal the spaces located at two sides of the membrane electrode unit, respectively, and thus has the problems of misalignment and assembling, the sealing structure of the invention can be disposed on the conductive substrates in advance and then the other components are stacked thereon in order. Thus, the present invention can solve the problems of the prior art that uses two sealing bodies, and has the advantages of good sealing property and simpler assembling procedure.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A sealing structure applied to an electricity supply device, wherein the electricity supply device comprises two conductive substrates and a chemical-electrical conversion module disposed between the two conductive substrates, and the chemical-electrical conversion module comprises two diffusion units and a membrane electrode unit disposed between the two diffusion units, the sealing structure comprising:
a first protruding structure disposed against the conductive substrates, wherein at least one end of one of the diffusion units and at least one end of the membrane electrode unit are disposed against the inner side of at least one end of the first protruding structure; and
a second protruding structure disposed adjacent to the first protruding structure and against the membrane electrode unit and one of the conductive substrates, wherein at least one end of the other one of the conductive units is disposed against the inner side of at least one end of the second protruding structure.

2. The sealing structure according to claim 1, wherein the first protruding structure and the second protruding structure are separated components.

3. The sealing structure according to claim 1, wherein the first protruding structure and the second protruding structure are integrally formed as one piece.

4. The sealing structure according to claim 1, wherein at lest one of the first protruding structure and the second protruding structure is flexible.

5. The sealing structure according to claim 1, wherein at least one of the first protruding structure and the second protruding structure is made of silica gel, polyvinyl chloride (PVC), Polyethylene (PE), Polypropylene (PP), Polystyrene (PS), or their combinations.

6. The sealing structure according to claim 1, wherein the first protruding structure and the second protruding structure have the same dimension or different dimensions.

7. The sealing structure according to claim 1, wherein at least one of the first protruding structure and the second protruding structure is continuously or discontinuously disposed around the edge of the conductive substrate.

8. The sealing structure according to claim 1, wherein each of the conductive substrates has at least one reaction area and at least two fluid transmission areas.

9. The sealing structure according to claim 8, wherein the sealing structure is continuously or discontinuously disposed around the edge of the reaction area.

10. The sealing structure according to claim 8, wherein the sealing structure is continuously or discontinuously disposed around the edges of fluid transmission areas.

11. An electricity supply device, comprising:
two conductive substrates;
a chemical-electrical conversion module disposed between the two conductive substrates, and comprising two diffusion units and a membrane electrode unit disposed between the two diffusion units, wherein one of the two diffusion units is disposed adjacent to one of the conductive substrates, and the other one of the two diffusion units is disposed adjacent to the other one of the conductive substrates; and
a sealing structure comprising:
a first protruding structure disposed against the two conductive substrates, wherein at least one end of one of the diffusion units and at least one end of the membrane electrode unit are disposed against the inner side of at least one end of the first protruding structure, and
a second protruding structure disposed adjacent to the first protruding structure, wherein at least one end of the second protruding structure is disposed against at least one end of the membrane electrode unit and at least one end of one of the conductive substrates, and at least one end of the other one of the conductive units is disposed against the inner side of at least one end of the second protruding structure.

12. The electricity supply device according to claim 11, wherein each of the conductive substrates has at least one reaction area and at least two fluid transmission areas, and the reaction area is disposed corresponding to the chemical-electrical conversion module.

13. The electricity supply device according to claim 12, wherein the reaction area comprises at least one fluid channel.

14. The electricity supply device according to claim 12, wherein the sealing structure is continuously or discontinuously disposed around the edge of the reaction area.

15. The electricity supply device according to claim 12, wherein the sealing structure is continuously or discontinuously disposed around the edges of fluid transmission areas.

16. The electricity supply device according to claim 11, wherein at least one of the conductive substrates has a surface configured with at least one positioning structure, and the positioning structure is disposed corresponding to the sealing structure.

17. The electricity supply device according to claim 11, wherein at least one of the conductive substrates has a surface configured with at least one fixing structure for fixing the sealing structure.

18. The electricity supply device according to claim 11, wherein the membrane electrode unit comprises:
two catalyze units, wherein one of the catalyze units is disposed between one of the conductive substrates and one of the diffusion units, and the other one of the catalyze units is disposed between the other one of the conductive substrates and the other one of the diffusion units; and
a proton exchanging unit disposed between the two catalyze units.

19. The electricity supply device according to claim 11, wherein the first protruding structure and the second protruding structure are separated components or integrally formed as one piece.

20. The electricity supply device according to claim 11, wherein at lest one of the first protruding structure and the second protruding structure is flexible.

21. The electricity supply device according to claim 11, wherein at least one of the first protruding structure and the second protruding structure is made of silica gel, polyvinyl chloride (PVC), Polyethylene (PE), Polypropylene (PP), Polystyrene (PS), or their combinations.

22. The electricity supply device according to claim 11, wherein the first protruding structure and the second protruding structure have the same dimension or different dimensions.

23. The electricity supply device according to claim 11, wherein the electricity supply device is a fuel cell device.
